(19) United States
(12) Patent Application Publication
(10) Pub. No.: US 2004/0085293 A1
(43) Pub. Date: May 6, 2004

(54) Spatial data management system and method

(76) Inventors: Craig Ivan Soper, Wellington (NZ); Andrew Stewart, Wellington (NZ)

Correspondence Address: David E. Bruhn, DORSEY & WHITNEY LLP, Intellectual Property Department, 50 South Sixth Street, Suite 1500, Minneapolis, MN, 55402-1498, US

(21) Appl. No.: 10/692,410

(22) Filed: Oct. 23, 2003

Related U.S. Application Data
(63) Continuation of application No. 09/674,346, filed on Feb. 21, 2001, now abandoned.
Application No. 09/674,346 is a 371 of international application No. PCT/NZ00/00101, filed on Jun. 19, 2000.

(30) Foreign Application Priority Data
Jun. 18, 1999 (NZ) 336340

(51) Int. Cl. G09G 5/00

(52) U.S. Cl. 345/156

(57) ABSTRACT

The invention provides a spatial data management system comprising a memory in which is maintained a spatial database of position data representing the position of one or more objects; retrieval means arranged to retrieve the position data representing one or more objects from the spatial database; display means arranged to display to a user a graphical spatial representation of one or more objects generated from the position data; editor means arranged to enable the user to edit the graphical spatial representation displayed by the display means; and updating means arranged to store in the spatial database position data representing the edited spatial representation. The method also provides a method of spatial data management and a computer program for spatial data management.

### FIELD OF INVENTION

The invention relates to a spatial data management system and method, particularly but not solely designed for maintaining and managing gaming machines and tables in a casino for managing floor layouts in a retail premises, or for managing the storage or layout of goods in a warehouse.

### BACKGROUND TO INVENTION

Maintaining and managing the location of gaming machines has traditionally proved to be difficult for a casino operator. Casinos typically contain a large number of gaming machines located in diverse locations within the building. The machines, for example, may be positioned in several rooms spread over several floors of the building.

When changes are made to casino layouts, it is often difficult for a casino operator to know how effective those changes have been in increasing revenue. It would be particularly useful for a casino operator to have available a convenient and user friendly system to record changes to floor layouts.

### SUMMARY OF INVENTION

In broad terms, the invention comprises a spatial data management system comprising a memory in which is maintained a spatial database of position data representing the position of one or more objects; retrieval means arranged to retrieve the position data representing one or more objects from the spatial database; display means arranged to display to a user a graphical spatial representation of one or more objects generated from the position data; editor means arranged to enable the user to edit the graphical spatial representation displayed by the display means; and updating means arranged to store in the spatial database position data representing the edited spatial representation.

In another form in broad terms, the invention comprises a computer program for spatial data management comprising a spatial database of position data maintained in a memory, the position data representing the location of one or more objects; retrieval means arranged to retrieve the position data representing one or more objects from the spatial database; display means arranged to display to a user a graphical spatial representation of one or more objects generated from the position data; editor means arranged to enable the user to edit the graphical spatial representation displayed by the display means; and updating means arranged to store in the spatial database position data representing the edited spatial representation.

In yet another form in broad terms, the invention comprises a method of spatial data management comprising the steps of maintaining in a memory a spatial database of position data representing the location of one or more objects; retrieving the position data representing one or more objects from the spatial database; displaying to a user a graphical spatial representation of one or more objects generated from the position data; providing editor means to enable the user to edit the graphical spatial representation displayed by the display means; and storing in the spatial database position data representing the edited spatial representation.

### BRIEF DESCRIPTION OF THE FIGURES

Preferred forms of the spatial data management system and method will now be described with reference to the accompanying figures in which:

FIG. 1 shows a block diagram of a system in which the invention may be implemented;

FIG. 2 shows the preferred system architecture of hardware on which the present invention may be implemented;

FIG. 3 is a preferred representation generated in accordance with the invention;

FIG. 4 is a preferred database schema;

FIG. 5 is a flow chart of a preferred form of the invention;

FIG. 6 is a main window of one implementation of the invention;

FIG. 7 is a tool bar forming part of the window of FIG. 6;

FIG. 8 is an information window forming part of the window of FIG. 6; and

FIG. 9 is a data visualisation generated in accordance with one form of the invention.

### DETAILED DESCRIPTION OF PREFERRED FORMS

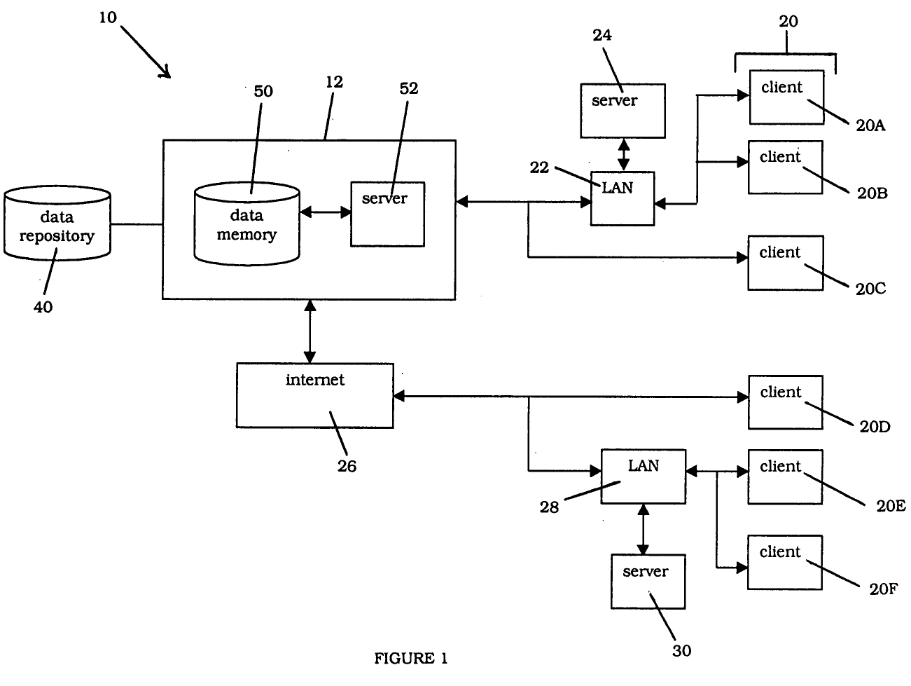

FIG. 1 illustrates a block diagram of the preferred system 10 in which the present invention 12 may be implemented. The system includes one or more clients 20, for example 20A, 20B, 20C, 20D, 20E and 20F, which each may comprise a personal computer or workstation described below. Each client 20 is interfaced to the invention 12 as shown in FIG. 1. Each client 20 could be connected directly to the invention 12, could be connected through a local area network or LAN, or could be connected through the Internet.

Clients 20A and 20B, for example, are connected to a network 22, such as a local area network or LAN. The network 22 could be connected to a suitable network server 24 and communicate with the invention 12 as shown. Client 20C is shown connected directly to the invention 12. Clients 20D, 20E and 20F are shown connected to the invention 12 through the Internet 26. Client 20D is shown as connected to the Internet 26 with a dial-up connection and clients 20E and 20F are shown connected to a network 28 such as a local area network or LAN, with the network 28 connected to a suitable network server 30.

The preferred system 10 further comprises a data repository 40 which in a preferred form comprises a single database or a collection of databases, particularly a spatial database which is further described below. It is envisaged that the data repository may alternatively comprise a data warehouse or a data mart.

One preferred form of the invention 12 comprises a personal computer or workstation operating under the control of appropriate operating and application software having a data memory 50 connected to a server 52. The invention is arranged to retrieve data from the data repository 40, process the data with the server 52 and to display the data on a client workstation 20, as will be described below. It is envisaged that data could also be stored temporarily in data memory 50.

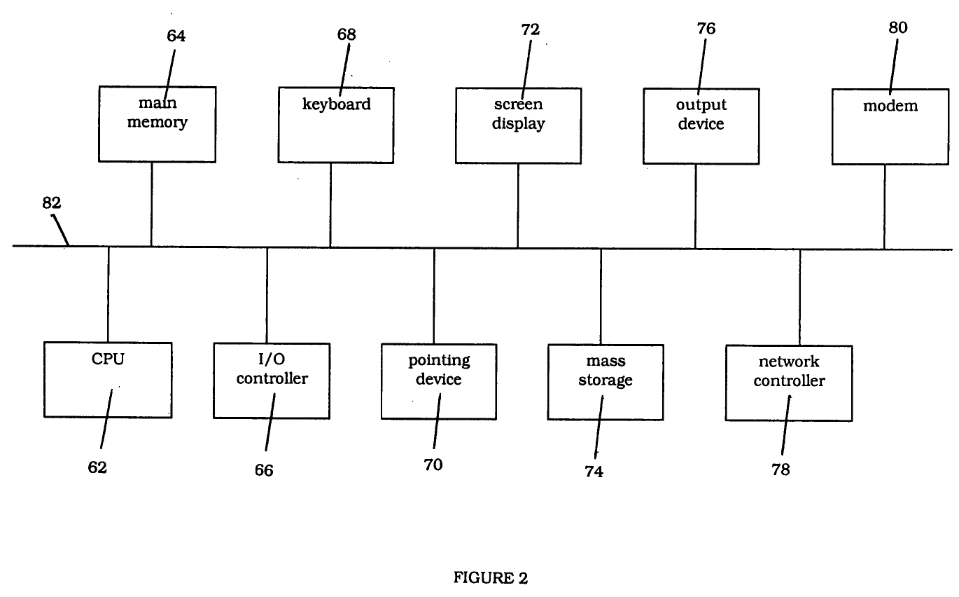

FIG. 2 shows the preferred system architecture of the invention 12 and client 20. The computer system 60 typically comprises a central processor 62, a main memory 64 for example RAM, and an input/output controller 66. The computer system 60 also comprises peripherals such as a keyboard 68, a pointing device 70 for example a mouse, touch pad or track ball, a display or screen device 72, a mass storage memory 74 for example a hard disk, floppy disk or optical disc, and an output device 76 for example a printer. The system 60 could also include a network interface card or controller 78 and/or a modem 80. The individual components of the system 60 could communicate through a system bus 82.

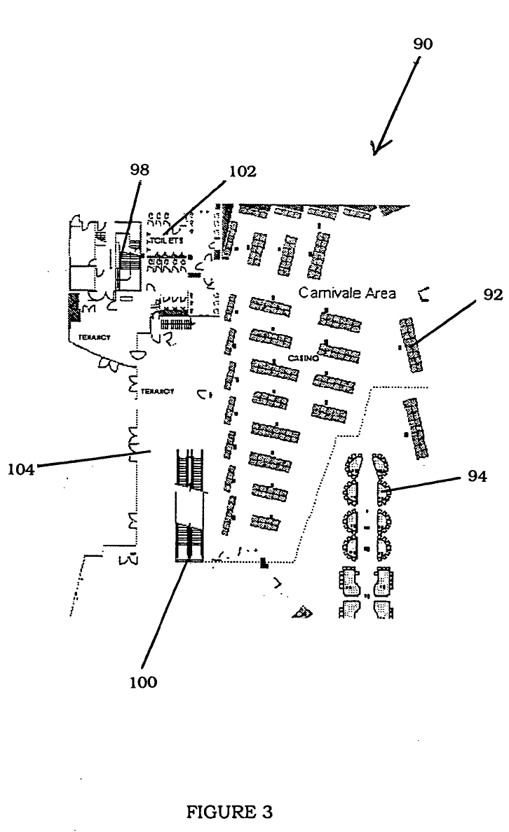

FIG. 3 illustrates one example of a display 90 generated by the system, where the merchant operates a casino or similar gaming venue. It is envisaged that the invention display the premises of a merchant by displaying individual objects on a merchant premises. Typically, a merchant will operate in a commercial premises or store from which a customer purchases goods or services. The merchant may, for example, operate a petrol station in one or more geographic locations. In this case, the system may be arranged to store and display objects such as individual shelves and stands within a retail environment.

The representation generated by the system is shown as a graphical spatial representation of the premises of the merchant. The display includes spatial information relating to one or more objects, for example gaming machines indicated at 92 and gaming tables indicated at 94. The preferred representation also includes other objects, for example stairwells 98, escalators 100, toilet facilities 102, and doorways 104.

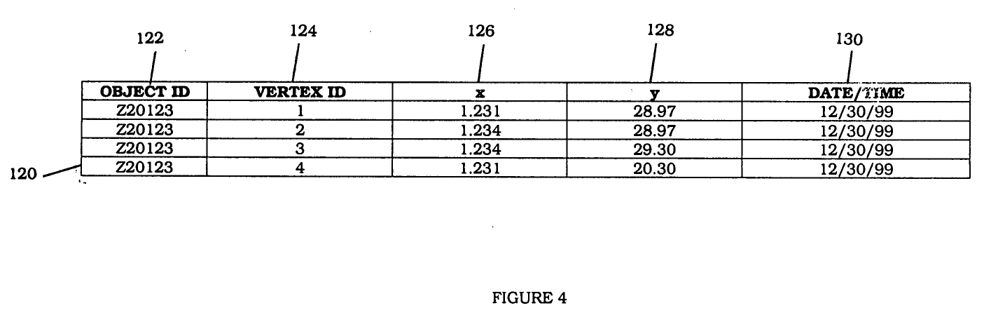

FIG. 4 illustrates a preferred form database schema 120 suitable for maintaining position data representing the location of one or more objects such as the casino machines and tables. The schema 120 is shown as a single table in a relational database. It will be appreciated that this table could be normalised to an appropriate extent to avoid data redundancy. It will also be appreciated that schema 120 could alternatively be represented in an object-oriented form.

A typical record could include an object identifier 122 to identify a particular object such as a particular casino game or table. The record preferably represents each object as a set of vertices which together define a polygon representing a two-dimensional plan view of each object. Each data set preferably defines the geographic co-ordinates of the vertices of each polygon.

As shown in FIG. 4 for example, the schema 120 may include a vertex identifier 124 to identify an individual vertex of a particular object. Position data such as x coordinates indicated at 126 and y coordinates indicated at 128 could represent the geographic position of an individual vertex in the New Zealand Map Grid (NZMG) Local Co-ordinate System Notation. It is envisaged that the geographic co-ordinates could alternatively be represented in Australian Map Grid (AMG) Notation, in WGS84, or as a latitude or longitude, or in any other suitable map grid notation system.

The schema 120 could also include a date or time field 130 for storing the date or time a particular record is created or edited. This would enable the system to keep track of changes made to the positions of individual objects stored in the spatial database.

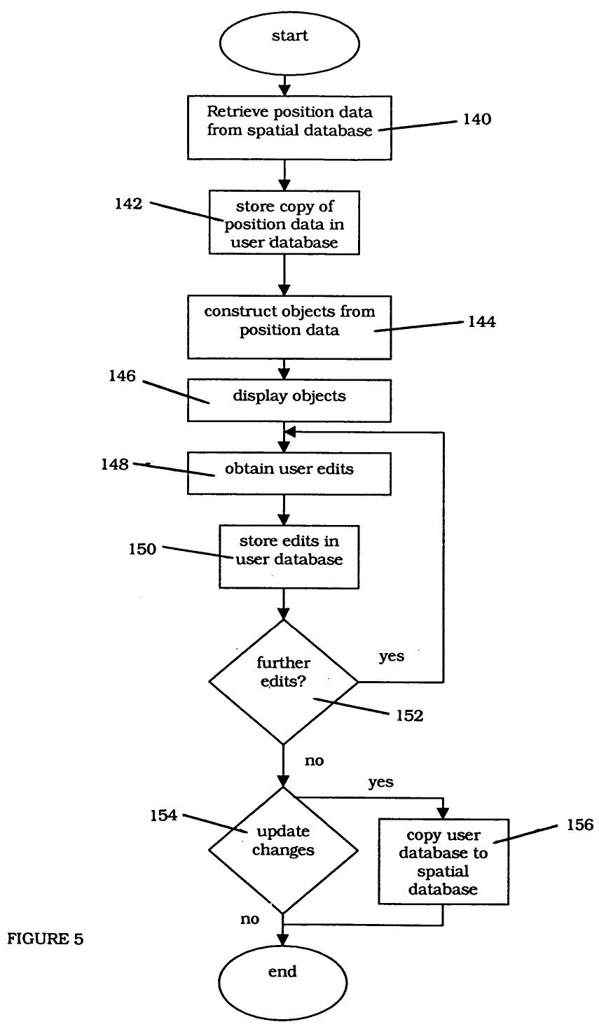

FIG. 5 illustrates one preferred method of operation of the invention 12. As shown at 140, data is retrieved from the spatial database by a suitable automated database query. The retrieved data could include position data representing the location of one or more objects in the spatial database.

As shown at 142, the system may be arranged to store a copy of the position data in a user database, which could be stored in data memory 50. This would enable any changes to be made to a copy of the data from the spatial database, enabling the system to roll back any changes or edits which are undesirable.

Referring to step 144, the system constructs objects from the position data retrieved from the spatial database. These objects, typically in the form of polygons, are then displayed to a user as indicated at step 146 in the form of a graphical spatial representation of the objects. The vertices of an individual object are preferably displayed on a display device in a position which corresponds to the geographic position of each vertex represented by geographic co-ordinates. Connecting lines between vertices are then calculated and displayed on the representation also.

As indicated at 148, any necessary changes required are obtained from the user. These changes could include for example, the addition of new objects, the deletion of existing objects, the repositioning of existing objects and/or rotation or other reorientation of individual objects.

Changes to the position data for individual objects are stored in the user database as indicated at 150.

If there are no further edits, as indicated at 152, the user is preferably requested to confirm that the changes made should be updated as indicated at 154. In the changes are not to be made, the system effectively rolls back to the last copy of the data in the spatial database. On the other hand, if the changes are to be updated, a copy of the user database is copied to the spatial database as indicated at 156.

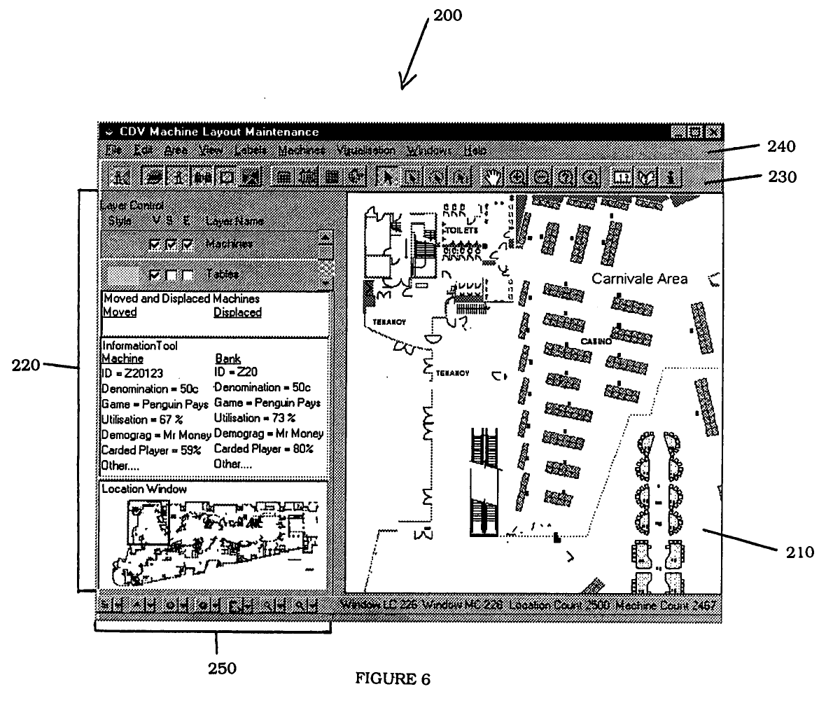

FIGS. 6 to 8 show one preferred implementation of the invention. FIG. 6 shows the preferred main window 200 presented to a user. The preferred window 200 comprises a map window 210, an all information window 220, a tool bar 230, menu items 240, and an intelligent tool bar 250. It is envisaged that window 200 may display more than one map window. Where more than one map window is displayed, the invention identifies one of these windows as being active.

The window 200 could be provided with a splitter bar (not shown) positioned between the map window 210 and the all information window 220. This splitter bar could provide the user with the option of resizing both window 210 and 220. Clicking on the bar and moving the mouse toward window 210 would reduce the area of window 210 and increase the area of window 220. Moving the mouse toward window 220 would reduce the area of window 220 and increase the area of window 210.

The map window 210 is arranged to display all the spatial information relating to a number of objects. The preferred form window 210 is arranged to display a graphical spatial representation of a casino building, together with machines and table layouts within the building, the machines and tables comprising objects in the system.

Individual machine locations are preferably displayed in a colour contrasting to that of the background of the map window and are outlined in a colour contrasting to both the machine and the background. Banks of machines and/or machine locations may be identified by a suitable label.

Where an individual machine is positioned at a particular machine location, the individual machine may be designated by a symbol, character, or some other label positioned over the machine location. As an individual machine is moved by the user to a different machine location, the invention may designate the moved machine with either a different symbol and/or a symbol of a different colour to distinguish the moved machines from the machines which remain in their original location.

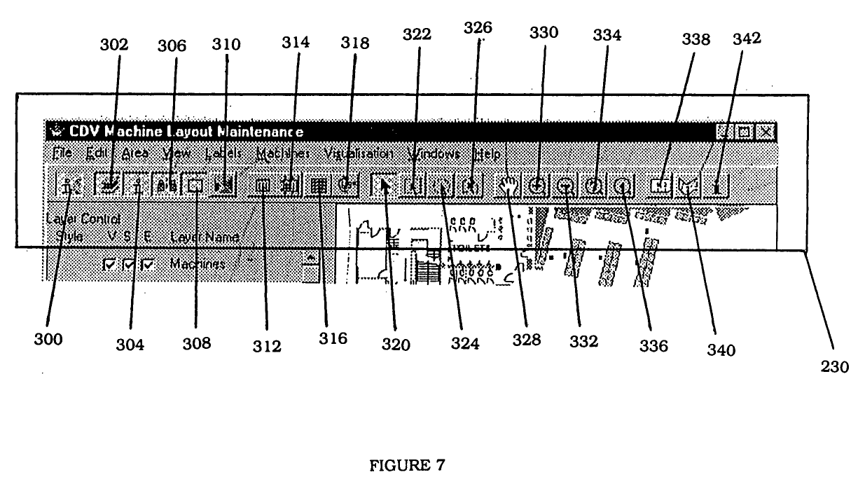

The preferred tool bar 230 includes a number of buttons, the functionality of which is described with reference to FIG. 7. The preferred tool bar is arranged so that when the user passes the cursor over a button, a hint or tool tip will be displayed detailing a word description of the purpose of the individual button.

Referring to FIG. 7, the preferred tool bar 230 includes all information button 300. By clicking this button, the user may open and close the all information window 220. As will be described below, the all information window 220 has a number of components. The tool bar 230 may include layer control button 302, information button 304, moved and displaced machines button 306, map location button 308, and thematic button 310. By clicking on these buttons, the user may open and close individual components of the all information window, for example a layer control window, an information window, a moved and displaced machines window, a map location window and a thematic window respectively. These windows are described below.

The tool bar 230 may include a new machine location button 312. By clicking on this button then clicking in map window 210, the user may add a new machine location at the position selected in the map window 210. The tool bar may also include new machine location by grid button 314 which adds a new machine location snapped to a grid. The tool bar may also include a new bank button 316 which adds a new machine bank location by clicking on the desired location on the map.

The rotate button 318 enables a user to rotate an object selected in the map window 210 by a prespecified angle, for example, 45°. Rotation could also be performed, for example, by conventional click and drag techniques.

The tool bar may include several buttons for selecting one or more objects in the map window. For example, the tool bar may include a select button 320 for selecting an individual object, a select by rectangle button 322 for selecting all objects by dragging the cursor over them, a select by radius button 324 and a select by polygon button 326 enabling a user to select a number of objects by drawing a shape around them.

The tool bar may also include a pan button 328 for moving the map window 210, a zoom in button 330 for decreasing the map scale, a zoom out button 332 for increasing the map scale, a zoom by attribute button 334 which allows a user to change the map scale by opening another window with a different map scale, and a previous view button 336 which reverts back to the previous view in the map window 210.

The tool bar 230 may also include a linear ruler button 338 and a non-linear ruler button 340 for measuring the distance between two or more points.

The tool bar 230 may also include an information button 342 to display information in the information window described below once the user clicks on the objects in the map window 210.

It will be appreciated that the tool bar 230 may comprise a subset of the buttons described above or may include additional buttons. The tool bar 230 may also be arranged as two or more tool bars providing the user with different sets of functions and permitting the user to select which of the tool bars will be displayed in the main window 200.

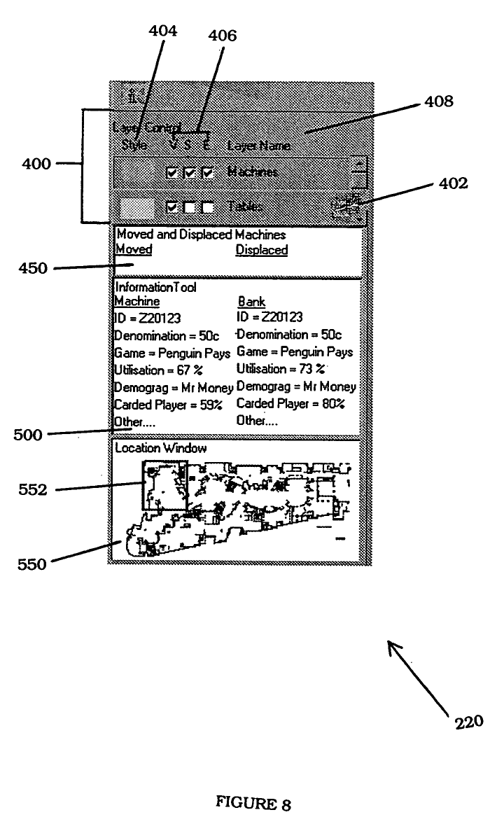

FIG. 8 illustrates the all information window 220. The preferred window displays information relating to the display in the map window 210 and also provides the user with tools necessary for editing objects in the map window. The preferred all information window 220 comprises five resident windows, namely a layer control window 400, a moved and displaced machines window 450, an information tool window 500, a map location window 550 and a thematic legend window (not shown).

The preferred all information window 220 is arranged so that any one of the resident windows can be resized and may additionally be opened or closed as described above with reference to the tool bar 230.

The preferred layer control window 400 manages the layers of spatial information in map window 210 and also acts as a legend for the map window. The layer control window comprises a number of rows of components accessible using scroll bar 402.

For each row in the layer control window, a user may specify the style 404 of a particular layer, for example, the colour in which a particular layer will be represented in the map window 210. Also provided are check boxes indicated at 406, for example a visible check box, a selectable check box and an editable check box.

By clicking in the visible check box, the user may specify whether a particular layer will be visible in the map window 210. By clicking the selectable check box, the user may select whether or not the particular layer will be selectable in the map window. By clicking in the editable check box, the user may specify whether a particular layer is to be editable in the map window.

The user may also specify a layer name 408, for example, “machines” or “tables”. The user may also select other layer names such as “walls”, “doors”, “stairs, sanitary”, and/or “pillars”.

The layer control window 400 could be provided with a drag and drop facility so that a user may rearrange the orders of the layers using the cursor. By clicking on one row, holding down the left mouse button, and moving the cursor, the user may alter the position of the selected row relative to the other rows in the window.

The moved and displaced window 450 presents to the user a “moved” column and a “displaced” column. It is envisaged that the window may alternatively be split into separate “moved” and “displaced” windows. As the user moves individual machines from one machine location to another machine location in the map window 210, the moved machines are represented in the moved column in window 450. This representation could include, for example, a location history.

If a machine is moved to a machine location already occupied by another machine, the original machine is listed in the displaced column. To assign a displaced machine with a location, the user may click on the displaced machine in the displaced column and then click on a machine location in map window 210. Alternatively the user may be permitted to click on a machine location in the map window 210, then double click on the desired machine in the displaced column. In each case the invention may require confirmation of placement from the user.

Where a user has selected the information toolbar item and clicks on a machine location in map window 210, the information window 500 is populated with information about that machine location, for example, the machine ID of a machine at that location, currency denomination, the name of the game, utilisation, demographics data and other information.

The map location window 550 is arranged to display and control the location of the map window 210 in relation to the entire floor plan of the casino. For example, where map window 210 shows the ground floor of a casino, the map location window 500 will also display the ground floor, and will highlight the area 552 shown in the map window 210.

Where the user has more than one map window open, the map location window 550 will display the particular map window which is active. For example if the active map window shows the ground floor of a casino, the map location window will also display the ground floor, whether or not the user is viewing other floors.

The all information window could also include a thematic legend window (not shown) arranged to display different colours for each denomination of machine, for example, 5¢, 10¢, 20¢, 50¢ and $1.

As shown in FIG. 6, the main window 200 could include a number of menu items 240. The preferred menu headings comprise File, Edit, Area, View, Labels, Machines, Visualisation, Windows, and Help.

The File menu could present options to the user such as create new file, open existing file, save current file, save current file under a new name, save scenario as master (ie. update changes), save a thematic window, undo all changes to the last saved version, print front or active window, print a report for a particular user and close the program.

The Edit menu could present options such as undo the last change, redo the last action, repeat the last command, cut object to clipboard, copy object to clipboard, paste clipboard item, select all the items, open a search window, and replace the selected object with clipboard item.

The Area menu could enable a user to select a particular area and to zoom to the extent of this area. This area could include, for example, the whole casino, the ground floor, or a particular room within the casino.

The View menu could enable the user to create a thematic map using a variable defined by selection of a menu item. Typical menu items could be Denomination, Manufacturer, Game, Height and Modified.

The Labels menu heading could enable a user to label the map shown in map window 210 using a variable defined by selection of a menu item. Typical items for menu selection comprise Denomination, Manufacturer, Game and Height.

The Machines menu could present to the user options such as put application into edit mode enabling the user to assign machines to locations, open a window for parameter entry, and add a list of new machines from a file.

The invention in one preferred form may be arranged to display a contoured representation of data superimposed on the graphical spatial representation of the premises of the merchant generated by the system. Contoured representations are further described in our patent specification PCT/NZ00/????? to Compudigm International Limited filed on 14 Jun. 2000 entitled “Data visualisation system and method” which is incorporated by reference.

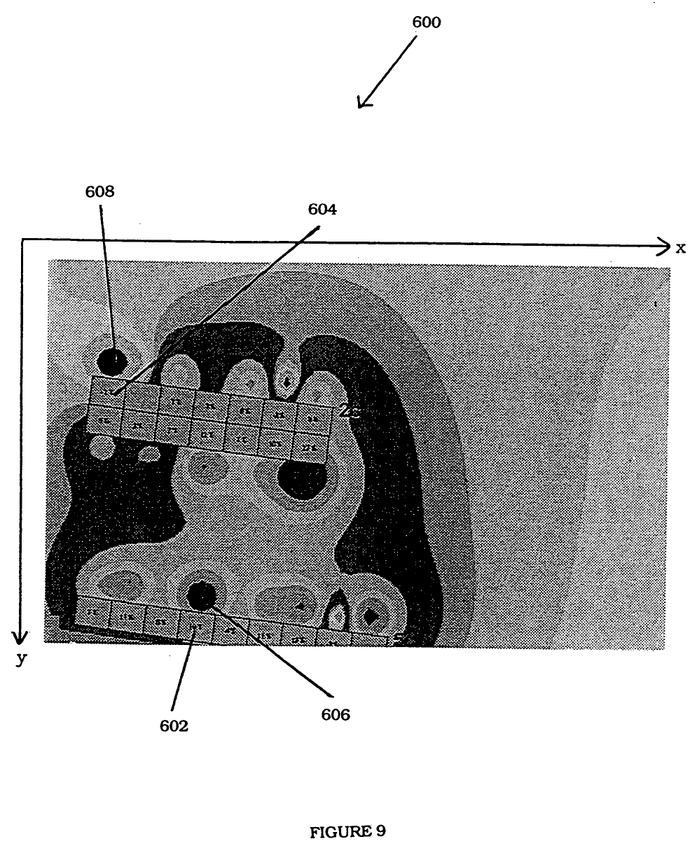

FIG. 9 illustrates at 600 one example of a display generated by the system where the merchant operates a casino or similar gaming venue. In this example, a representation of the merchant is generated and displayed in accordance with the invention. The graphical representation comprises a spatial representation of an area of the casino showing the layout of individual gaming machines and stations, two of which are indicated at 602 and 604 respectively.

The representation 600 is arranged to display the revenue obtained from an individual gaming machine. The revenue for each machine is preferably graphically represented adjacent or near to the representation of the individual machine. There are a finite number of machines in the casino, and the individual revenues generated from each machine represent a finite set of data values. These data values are graphically illustrated as data points in the representation 600. For example, the revenue or data value for machine 602 is graphically illustrated as data point 606 and the data value or revenue for machine 604 is graphically illustrated as data point 608.

The preferred representation 600 is colour coded and the value of revenue of each machine is illustrated by representing the corresponding data points in the appropriate colour to represent the correct value of revenue of each machine.

The areas of the representation 600 around each data point are shown as contours. The nature of the contours for each data point are preferably represented to gradually drop off or fall away from each data point. Each data point could be represented by x and y co-ordinates indicating the relative position of each data point in the representation. Each data point could also have a z value representing the height or magnitude of the data point. This z value could indicate, for example, the revenue or data value at a particular data point. Each data value is therefore centred on a data point.

Referring to FIG. 6, the Visualisation menu could enable a user to create a visualisation or to produce a report with options such as open a window in which the user can define a set of criteria where a data visualisation will be created such as revenue, and open a window where the user can define a set of criteria where a data visualisation report will be created.

The Windows menu could provide the user with options such as show information window, create a new map window, create a new browser window, and list all open windows enabling a user to click on one of the windows in the list which will become the front or active window.

The user may also be provided with a Help menu heading, which could provide an About dialog box and Help File contents in the known way.

It is envisaged that the actual menu headings and menu items of the system may comprise a subset of the menu headings and menu items described above. It is also envisaged that the menu headings and menu items may include menu headings and menu items in addition to those described above.

The main window 200 may also include an intelligent tool bar 250 having a number of smart buttons as shown in FIG. 6. These smart buttons are arranged to store their last action and then reperform the action when clicked by the user. Each smart button has positioned adjacent to it a corresponding drop down list. By clicking on the drop down list for a particular smart button, the user is presented with a list of options from which to select. The option selected by the user will be remembered by the smart button and actioned the next time the smart button is clicked.

The intelligent tool bar 250 may include a denomination button which creates a thematic map detailing the user defined selection of denomination. For example, if the user selects 5¢, then all of the 5¢ machine locations will be highlighted a different colour. The tool bar 250 may also include a manufacturer button arranged to create a thematic map detailing the user defined selection of manufacturer, a game button arranged to create a thematic map detailing the user defined selection of game in which all games will be coloured a different colour, a height button arranged to create a thematic map detailing the user defined selection of height in which all machine heights will be coloured a different colour, and an expression button arranged to create a thematic map detailing the user defined selection of all the other attributes, for example, denomination, manufacturer and/or height.

The intelligent tool bar 250 may also include zoom buttons arranged to permit the user to define two different map scales and locations and to display the map scales and locations in map window 210 simply by clicking the zoom buttons.

The invention could also permit a user to perform functions in the map window 210 using the cursor and a mouse. For example, the user may navigate around the representation of the casino by holding down the left mouse button and moving the cursor in window 210 to the desired position on the casino floor.

By selecting a machine location, holding down the shift key, and moving the mouse, the user may move a machine location in window 210 to a new position on the casino floor. The invention could display a blue box or rectangle to indicate the new machine location.

The user may also move a machine by first selecting a machine, then holding down the control key, holding down the left mouse button and moving the cursor in window 210 to the desired new machine location on the casino floor for the machine. The new location selected by the user could be indicated by, for example, a red box or rectangle.

The invention could also provide the user with the options of zooming in or zooming out. To zoom in the user may hold down the right mouse button and move the cursor to define an area on which the user wishes to zoom in. To zoom out the user may hold down the shift key, hold down the right mouse button and move the cursor to define an area from which the user wishes to zoom out.

It is envisaged that the invention may provide zoom layering. For example, when a user views an entire casino floor in the map window 210, the objects in the window could be displayed without labels. If the user zooms to an area within the casino floor then the map window could display object labels, different object layers, and other finer points of detail.

The preferred spatial server records temporal data in addition to spatial data to permit a user to query historical changes to the spatial data. This would permit a user to, for example, experiment with new layouts and compare the effectiveness of those new layouts with historical layouts. The invention could produce change reports by comparing a current edited layout with the master layout, or with a historical layout.

In summary the invention provides a spatial data management system designed to assist a user in maintaining and managing gaming machines in a casino. It will be appreciated that the same invention could also have application in other areas, for example floor layout in a retail premises, or the storage or layout of goods in a warehouse.

The foregoing describes the invention including preferred forms thereof. Alterations and modifications as will be obvious to those skilled in the art are intended to be incorporated within the scope hereof, as defined by the accompanying claims.

1. A spatial data management system comprising:
a memory in which is maintained a spatial database of position data representing the location of one or more objects;
retrieval means arranged to retrieve the position data representing one or more objects from the spatial database;
display means arranged to display to a user a graphical spatial representation of one or more objects generated from the position data;
editor means arranged to enable the user to edit the graphical spatial representation displayed by the display means; and
updating means arranged to store in the spatial database position data representing the edited spatial representation.

2. A spatial data management system as claimed in claim 1 wherein the position data comprises one or more data sets, each data set representing the geographic co-ordinates of one object.

3. A spatial data management system as claimed in claim 2 wherein each data set defines a polygon having three or more vertices representing the object, each data set defining the geographic co-ordinates of the vertices of the polygon.

4. A spatial data management system as claimed in any one of the preceding claims wherein the editor means is arranged to enable the user to alter the location of one or more objects.

5. A spatial data management system as claimed in any one of the preceding claims wherein the editor means is arranged to enable the user to add objects to or delete objects from the spatial database.

6. A spatial data management system as claimed in any one of the preceding claims wherein the position data further comprises an object identifier for each object.

7. A spatial data management system as claimed in claim 6 wherein the position data further comprises temporal data, and the retrieval means is arranged to retrieve position data based in part on the temporal data.

8. A spatial data management system as claimed in any one of the preceding claims wherein the spatial database represents the commercial premises of a merchant, the display means arranged to display a graphical spatial representation of the premises of the merchant.

9. A spatial data management system as claimed in claim 8 wherein the merchant operates a casino or gaming venue.

10. A spatial data management system as claimed in claim 9 wherein the objects represented by the position data comprise gaming machines and/or gaming tables.

11. A computer program for spatial data management comprising:
a spatial database of position data maintained in a memory, the position data representing the location of one or more objects;
retrieval means arranged to retrieve the position data representing one or more objects from the spatial database;
display means arranged to display to a user a graphical spatial representation of one or more objects generated from the position data;
editor means arranged to enable the user to edit the graphical spatial representation displayed by the display means; and
updating means arranged to store in the spatial database position data representing the edited spatial representation.

12. A computer program as claimed in claim 11 wherein the position data comprises one or more data sets, each data set representing the geographic co-ordinates of one object.

13. A computer program as claimed in claim 12 wherein each data set defines a polygon having three or more vertices representing the object, each data set defining the geographic co-ordinates of the vertices of the polygon.

14. A computer program as claimed in any one of claims 11 to 13 wherein the editor means is arranged to enable the user to alter the location of one or more objects.

15. A computer program as claimed in any one of claims 11 to 14 wherein the editor means is arranged to enable the user to add objects to or delete objects from the spatial database.

16. A computer program as claimed in any one of claims 11 to 15 wherein the position data further comprises an object identifier for each object.

17. A computer program as claimed in claim 16 wherein the position data further comprises temporal data, and the retrieval means is arranged to retrieve position data based in part on the temporal data.

18. A computer program as claimed in any one of claims 11 to 17 wherein the spatial database represents the commercial premises of a merchant, the display means arranged to display a graphical spatial representation of the premises of the merchant.

19. A computer program as claimed in claim 18 wherein the merchant operates a casino or gaming venue.

20. A computer program as claimed in claim 19 wherein the objects represented by the position data comprise gaming machines and/or gaming tables.

21. A computer program as claimed in any one of claims 11 to 20 embodied on a computer readable medium.

22. A method of spatial data management comprising the steps of:
maintaining in a memory a spatial database of position data representing the location of one or more objects;
retrieving the position data representing one or more objects from the spatial database;
displaying to a user a graphical spatial representation of one or more objects generated from the position data;
providing editor means to enable the user to edit the graphical spatial representation displayed by the display means; and
storing in the spatial database position data representing the edited spatial representation.

23. A methed of spatial data management as claimed in claim 22 wherein the position data comprises one or more data sets, each data set representing the geographic co-ordinates of one object.

24. A method of spatial data management as claimed in claim 23 wherein each data set defines a polygon having three or more vertices representing the object, each data set defining the geographic co-ordinates of the vertices of the polygon.

25. A method of spatial data management as claimed in any one of claims 22 to 24 further comprising the step of arranging the editor means to enable the user to alter the location of one or more objects.

26. A method of spatial data management as claimed in any one of claims 22 to 25 further comprising the step of arranging the editor means to enable the user to add objects to or delete objects from the spatial database.

27. A method of spatial data management as claimed in any one of claims 22 to 26 wherein the position data further comprises an object identifier for each object.

28. A method of spatial data management as claimed in claim 27 wherein the position data further comprises temporal data, and the retrieval means is arranged to retrieve position data based in part on the temporal data.

29. A method of spatial data management as claimed in any one of claims 22 to 28 wherein the spatial database represents the commercial premises of a merchant, the method further comprising the step of displaying a graphical spatial representation of the premises of the merchant.

30. A method of spatial data management as claimed in claim 29 wherein the merchant operates a casino or gaming venue.

31. A method of spatial data management as claimed in claim 30 wherein the objects represented by the position data comprise gaming machines and/or gaming tables.
